(19) United States
(12) Patent Application Publication
(10) Pub. No.: US 2009/0131173 A1
(43) Pub. Date: May 21, 2009

(54) Electronic elimination game system and method

(76) Inventor: Lori A. Gurnsey, Altha, FL (US)

Correspondence Address: J. CHARLES DOUGHERTY, 200 WEST CAPITOL AVE, SUITE 2300, LITTLE ROCK, AR, 72201, US

(21) Appl. No.: 11/986,173

(22) Filed: Nov. 20, 2007

(51) Int. Cl. A63F 13/12; A63F 9/24

(52) U.S. Cl. 463/42

(57) ABSTRACT

A system and method for an elimination game is disclosed in which game points are stored by means of an “e-clip.” These points may represent, for example, simulated ammunition, “healing” points, charges or uses associated with a game item, and the like. The e-clip may be recharged by various means, each recharge being associated with a fee. An operator of a field where the game is played may thus efficiently generate revenue through use of the device to which the “e-clip” is associated.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to elimination games, and in particular to elimination games using emitters that involve the storage or transfer of digital information that is relevant to game play.

2. Brief Description of the Related Art

Elimination games, particularly elimination games that involve the use of a marker or emitter used to eliminate players on an opposing team, have become increasingly popular in recent years. Perhaps the most popular such game is paintball. Paintball is a sport in which players eliminate their opponents from play by hitting them with “paintballs,” which are spherical gelatin capsules containing polyethylene glycol, other non-toxic and water-soluble substances, and dye. The paintballs are shot from a compressed gas-powered gun called a “marker.” The first paintball markers were developed for the marking of trees in forestry applications in the late 1950's, but were not used as part of a paintball game until around 1981. Since then, numerous companies have developed specialized markers, paintballs, protective gear, barriers, and many other types of equipment for the sport. Paintball may be played either indoors or outdoors, and the rules for playing paintball vary widely. A game of paintball usually involves two opposing teams seeking to eliminate all of the other team's players, or to complete an objective such as retrieving a flag or eliminating a specific player on the other team.

One problem with the paintball game is that while a player is eliminated if struck by a paintball in a designated area of the body, the paintballs do not perform flawlessly, and sometimes may not burst upon impact. As a result, a paintball hit may fail to leave a visible mark. In addition, a player wearing heavy clothing may not always feel the impact of a paintball, and continue playing without realizing that a hit was made. Unscrupulous players may even wipe off marking paint when out of sight of opposing players, thereby continuing play despite being eliminated from further play under applicable game rules. Another problem with the paintball game is the relatively limited nature of the equipment used for playing. A marker is capable of doing only one thing, that is, marking another player for purposes of scoring a “hit.” The marker provides no means of keeping up with other information that may improve or enhance game play. Yet another problem with paintball is that markers have a relatively high failure or “jam” rate. For most paintball markers, as the rate at which a player fires paintballs increases, the likelihood that a paintball will burst within the marker also increases. Often a burst paintball means that the player must stop playing in order to clean his or her marker, effectively eliminating the player from the game for a period of time, or leaving the player defenseless against opposing players.

“Airsoft,” an increasingly popular alternative to paintball, was developed in Japan during the late 1980's. Instead of using markers firing paint-filled balls, the simulated guns used in an airsoft game fire small plastic pellets. The pellets may be launched by a spring mechanism in the simplest airsoft guns, but electrical and gas-powered mechanisms are also employed. Because of the relatively simple mechanism used to fire these pellets, airsoft guns may be made to appear very similar to real firearms, and thus airsoft appeals to military simulation and re-enactment enthusiasts. Unlike paintball, however, the pellet fired by an airsoft gun leaves no mark on the clothing of the eliminated player, and thus players must largely trust one another to identify when a “hit” has been scored. Since airsoft pellets generally strike with less energy than a paintball due to their reduced weight, a hit may be more likely to go unnoticed on a player wearing heavy clothing. Finally, airsoft guns, also like paintball markers, lack any means of enhancing game play or storing or transferring any information other than the ability to score a hit against an opposing player.

“Laser tag” is another elimination game related to paintball and airsoft. This game developed from training equipment first deployed by the United States Army during the late 1970's. In the laser tag game, players use hand-held emitters or “taggers” that emit an infrared beam. Each player in the game wears one or more infrared targets, which may be positioned on the. player's chest, head, arms, legs, or even the player's tagger itself. When a tagger is pointed at a target and a beam is emitted, an audible and/or visible alert indicates that a hit has been scored. A visible laser is sometimes added to the tagger for effect, although this laser has no real effect on game play other than perhaps improving the aim of the player using the tagger. While the early laser tag systems were generally restricted to use indoors or at night due to their low power, systems are now available that operate in full sunlight.

An advantage of the laser tag game is the ability of the tagger in some more sophisticated systems to encode information in the infrared signal. This information may include, for example, a code indicating the identity of the player or team who was firing the tagger. This coding system allows for more complex scoring systems, and also may allow an arena operator to control the use of unauthorized taggers in the play area. The taggers and the targets may be linked in communication with a control computer to keep track of hits and scores in various types of game play options.

While each of the games described above may be played by individuals who personally own the necessary equipment and have access to an appropriate play area, it has become increasingly popular for third parties to maintain a play area and all necessary equipment and supplies for those persons wishing to engage in these games. Paintball “fields” in particular have become very popular, with the operator of the field generally supplying not only the play areas, but also paintballs, pressurized air or CO₂ tank refilling services, marker repair, referees, and other related supplies and services. The field operators often allow the players to bring their own markers, while also maintaining a supply of markers available for rent by those who do not own their own. Although less popular than paintball fields, numerous laser tag “arenas” are also in commercial operation, where similar supplies and services are provided to those persons who wish to engage in a game of laser tag. At laser tag arenas, the player is typically required to use the tagger supplied by the operator, since the technology requires interoperability of the tagger with other taggers, detectors, and perhaps other wireless equipment used to monitor and control game play.

It is believed by the inventors of the present invention that one of the primary reasons for the success of paintball fields, and the relative lack of success of laser tag arenas, is the profit generated by the paintball field operator's sale of paintballs. While not universal, the great majority of commercial paintball fields are FPO (“field-paint only”), which means that players using the field must purchase all paintballs to be used during play from the field operator. Even where the paintball field operator does not require the purchase of paintballs at the field, players will often purchase paintballs from the operator simply as a matter of convenience. The FPO policy of most paintball field operators may be justified as a safety concern, since otherwise players might use modified paintballs to gain an advantage in accuracy or distance but that would be unsafe for other players. Nevertheless, the FPO policy is an important profit generator since the paintball field operator can charge substantially more for paintballs than the price that might be paid through a bulk purchase at a typical discount retailer or other paintball seller. By contrast, laser tag arenas do not have an effective means to monetize the number of “shots” taken by players, since the player generally pays to play the game for a certain period of time or until a certain number of “hits” are scored against that player. It would thus be highly desirable to develop a means of more effectively monetizing the playing of an infrared or other electromagnetic marking technology-based game like laser tag, such that operators for these games could enjoy the same commercial success currently enjoyed by paintball field operators.

Another important limitation of the laser tag game when compared to paintball is the general absence of “scenario” games. In paintball, scenario games have become very popular in recent years. Scenario games are roughly based on the wargames in which military units engage, and are intended to simulate military field conditions as closely as possible. While laser tag games played in arenas usually last for only a few minutes, scenario paintball games generally last for hours, and sometimes as long as a full day or more. Given the large number of players often engaged in scenario play simultaneously, each member of a team will usually wear an armband of a particular color or other easily visible indicia for team identification. The players on each side may be assigned a particular role or area of expertise—such as demolitions, engineer, medic, spy, and the like—and are given unique equipment or abilities based upon the assigned role. A medic, for example, may be given the ability to “heal” players under certain circumstances by wiping off paint from a player hit by a paintball. As another example, a spy may be a player who is assigned to a particular team but actually plays for the opposing team, and whose mission is to learn the assigned team's plan and report back to the opposing team. An identification badge is generally worn by each player to allow referees to keep track of that player's role. A great number of different “missions” may be played in scenario paintball, such as “take and hold” (take control of a particular area and hold it against opposing players for a length of time) and “snipe” (team member must sneak into an area and hit a particular target or opposing team commander with a paintball). Simulated trip-wire activated explosive devices, mortars, even simulated armored vehicles and aircraft strikes may be employed. The great variety of these games may keep up the interest of players for whom paintball play itself has become familiar. While paintball field operators have made great use of scenario games, there has been no similar development for the operators of laser tag arenas. The inventors of the present invention believe that the reason for this is also related to the inefficiency of the available means of monetizing laser tag play. It would thus be highly desirable to develop a means of more effectively enabling scenario games using infrared-based or other electromagnetic emitter technology.

The limitations of the prior art are overcome, and the desires of the inventors achieved, by the present invention as described below.

### BRIEF SUMMARY OF THE INVENTION

The present invention is directed to an elimination game employing markers that emit an infrared beam or other electromagnetic signal; such markers will be referred to herein generally as “emitters.” Points are associated with the emitters by means of an “e-clip,” which as used herein means any storage mechanism capable of storing points for use with respect to an emitter. The points may represent many different things during game play, such as rounds of simulated ammunition, charges of a magical item, healing points, stun charges on a stun weapon, or the like. According to the present invention, points are purchased by players for use during game play, which allow for the monetization of the game just as the sale of paintballs in FPO fields allow for the monetization of paintball games. The use of emitters rather than paintball markers, however, allows for many more game play options and uses of the points during play. Points are distributed to a player's e-clip by means of a master control center associated with a field operator. The field operator purchases points through the master control center from a base, which thus controls the sale of all points associated with game play at all game fields using this system. In various embodiments, the e-clips may be associated with an “e-card,” which can be another digital storage mechanism, such as a smart card, magnetic card, or other information transfer method.

It is therefore an object of the present invention to provide for an effective means of monetizing elimination games using infrared or other electromagnetic signal-emitting markers.

It is a further object of the present invention to provide for a means of enabling numerous scenario-based games using infrared or other electromagnetic signal-emitting markers.

These and other features, objects and advantages of the present invention will become better understood from a consideration of the following detailed description of the preferred embodiments and appended claims in conjunction with the drawings as described following:

### BRIEF DESCRIPTION OF THE SEVERAL VIEWS OF THE DRAWINGS

FIG. 1 is an illustration of the structural components according to a particular embodiment of the present invention.

FIG. 2 is an illustration of the subcomponents of a master control center and charger according to a particular embodiment of the present invention.

FIG. 3 is an illustration of the subcomponents of a base according to a particular embodiment of the present invention.

FIG. 4 is an illustration of the subcomponents of an emitter and e-clip where the e-clip is physically separate from the emitter according to a particular embodiment of the present invention.

FIG. 5 is an illustration of the subcomponents of an emitter and e-clip where the e-clip is integrated with the emitter according to a particular embodiment of the present invention.

FIG. 6 is a flow chart illustrating the method steps of playing an elimination game according to a particular embodiment of the present invention.

FIG. 7 is a representation of the teams playing a game under a military combat configuration according to a particular embodiment of the present invention.

FIG. 8 is a representation of the teams playing a game under a fantasy-theme configuration according to a particular embodiment of the present invention.

### DETAILED DESCRIPTION OF PARTICULAR EMBODIMENT(S)

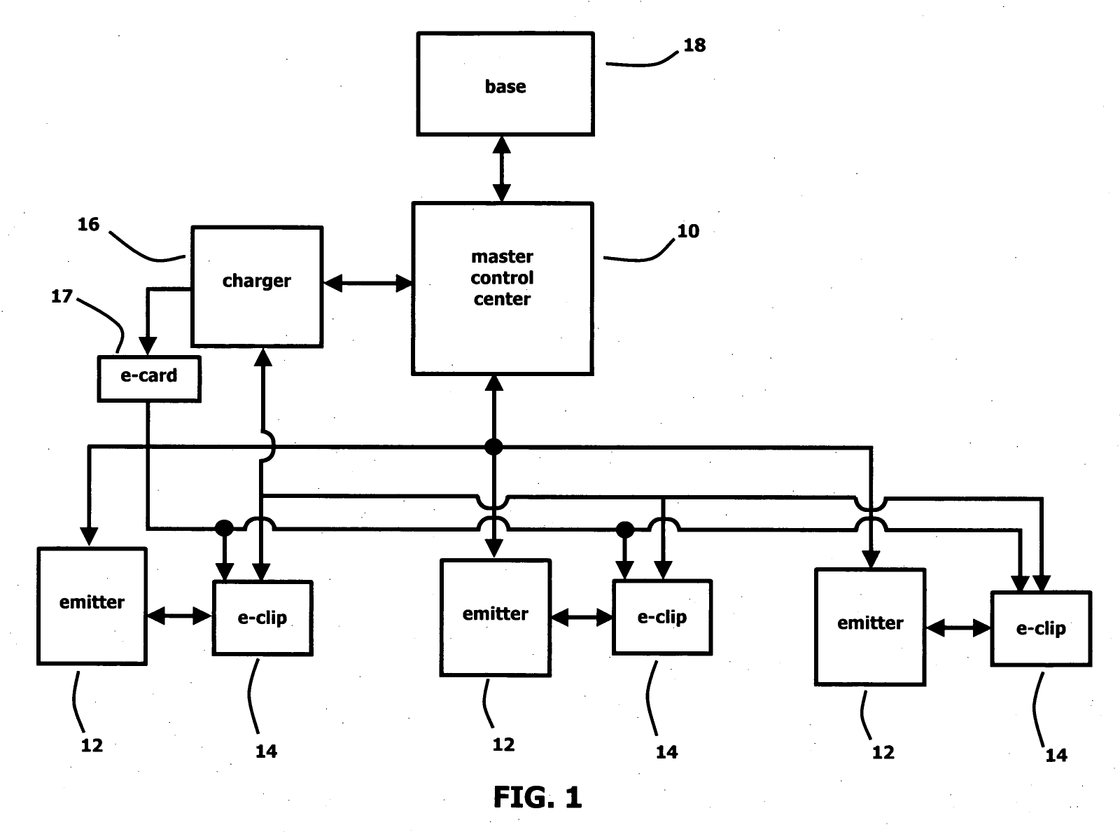

With reference to FIG. 1, the major components of a particular embodiment of the present invention may now be described. Those components are master control center 10, a plurality of emitters 12, a plurality of e-clips 14, charger 16, optional e-card or cards 17, and base 18. While three emitters 12 and three e-clips 14 are shown in FIG. 1, it should be understood that the invention may include any number of emitters 12 and e-clips 14, the number being limited to three each of these components in FIG. 1 for clarity. Also, it should be understood that there may be any number of master control centers 10 associated with a particular base 18, with each of the master control centers 10 being associated with a number of emitters 12 and e-clips 14; only one master control center 10 is also illustrated in FIG. 1 for reasons of clarity. As will be explained more fully below, these components are used as part of a game system in which a number of players each control an emitter 12, the function of which may be varied according to the specific parameters of the game chosen by the players. While each game takes place at a location referred to herein as a “field,” it should be understood that the invention may be used in any space with sufficient room to allow players to move around sufficiently to play the particular game chosen; such spaces may be indoor or outdoor, and may or may not include various types of structures or cover, whether man-made or natural.

Master control center 10 in the illustrated embodiment may be implemented as a personal computer or computer server running proprietary software with the functionality described herein, but could, in other embodiments, be implemented as an electronic hardware system designed specifically for this purpose. Master control center 10 may be physically present at the playing field, or may be at any remote location accessible by various types of networks, including the Internet. Alternatively, various subcomponents of master control center 10 may be located at physically remote locations; in one example, a wireless receiver may be placed at or near the field in order to communicate with emitters 12, while the receiver is provided with an Internet/intranet connection to allow it to communicate with a server in a remote location. In the illustrated embodiment, master control center 10 communicates with emitters 12 by means of a wireless electromagnetic communications network as known in the art, but in alternative embodiments the connection could be of any other form allowing information to pass between the components of the system, wired or wireless. One or more of the master control centers 10 could also be integrated with base 18, the structure and function of which will be explained in more detail below

Master control center 10 is operable to receive and transmit information from and to emitters 12 in order to manage system parameters during game play. These parameters may include, for example, the configuration required for each emitter in order to allow a player to participate in a particular chosen game. The information may also include, for example, the role or class assigned to each player in the game; the rank or experience level of each player; handicapping data for each player; player usage data; the number of points purchased by a player and stored on e-clip 14; the rate of fire allowed for each player's emitter 12; the number of “lives” allotted to a particular player, and how many of such lives have been used by each player; whether a time limit has been reached in the game; and the amount of time a particular player has participated in the game. These are merely examples of the type of data that may be tracked by master control center 10, and are not an exclusive list, as customized data may be used in particular game configurations or at particular fields.

Master control center 10 may also allow information to be transmitted between emitters 12, such as, for example, when a player has the game ability to “repair” or “recharge” the emitter 12 of another player, or to “heal” another player. The appropriate information could be transmitted to and from the emitters 12 operated by the affected players by communications between their emitters 12 and master control center 10. In alternative embodiments of the invention, the emitters 12 may have the capacity to directly communicate with each other without the need for master control center 10 to relay any information exchanges, although this information may still be sent to master control center 10 for tracking purposes.

Players may use e-cards 17 as an alternate means to charge e-clips 14 rather than directly charging them by means of charger 16. In the preferred embodiment, e-card 17 is a smart card of the type known in the art to store digital information, preferably in an encoded or encrypted format. E-clips 14 in this embodiment are designed to receive an e-card 17 by means of a slot or other electronic connection by which information may be transferred from an e-card 17 to an e-clip 14.

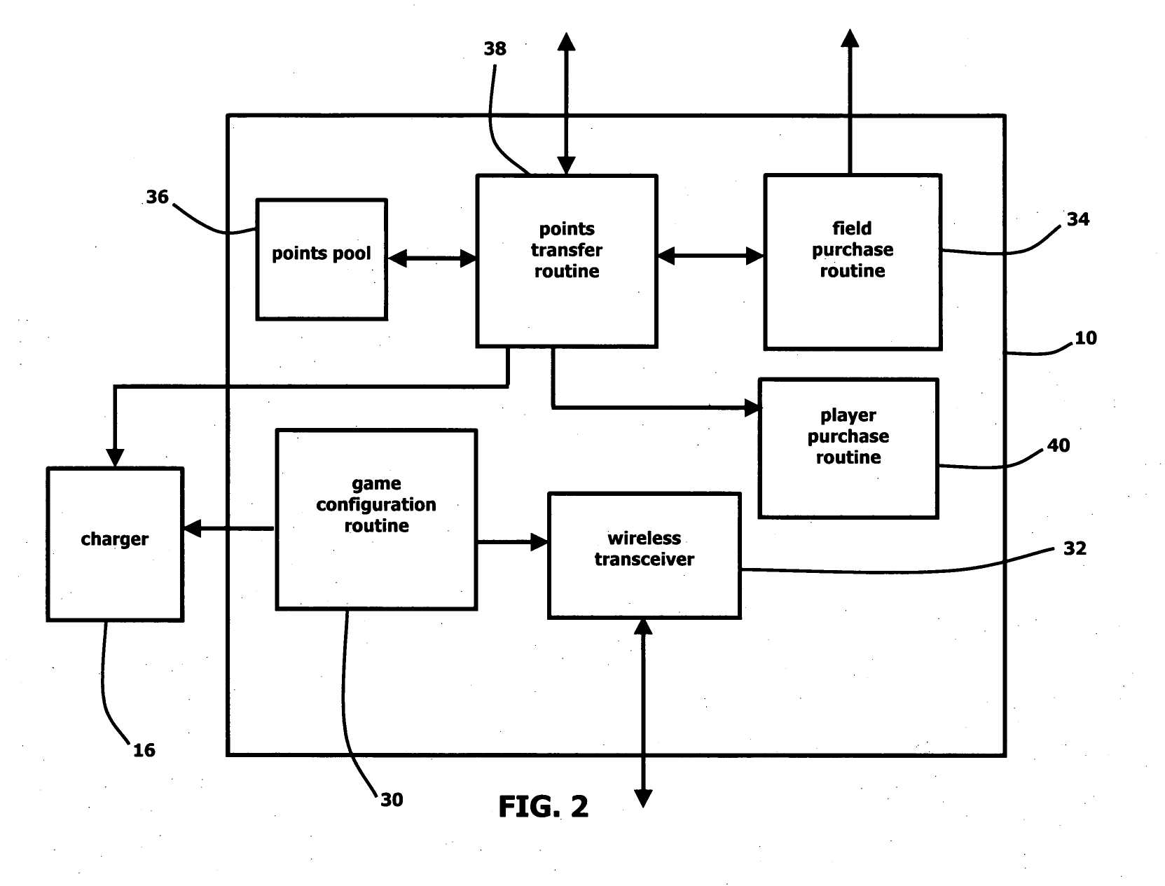

Referring now to FIG. 2, the subcomponents of master control center 10 operable to provide the functions described herein may be described. Game configuration routine 30 provides the functionality for setting up each of the parameters of a particular game. This information is communicated wirelessly to each emitter 12 by wireless transceiver 32. Wireless transceiver 32 also receives signals from emitter 12, as will be described below. Points are purchased from base 18 by the field operator at field purchase routine 34, and are transferred from base 18 to points pool 36 by points transfer routine 38. Points transfer routine 38 also enables the transfer of points from points pool 36 to charger 16 when points are purchased by a player from the field operator at player purchase routine 40. A storage-medium is employed to implement the points pool, which may be any type of magnetic, optical, solid state device, or other media capable of storing digital information, such as an “e-card.” Points transfer routine 38, field purchase routine 34, game configuration routine 30, and player purchase routine 40 may be implemented as either hardware or software, but they are a software routine executing on a typical microcomputer server in the illustrated embodiment.

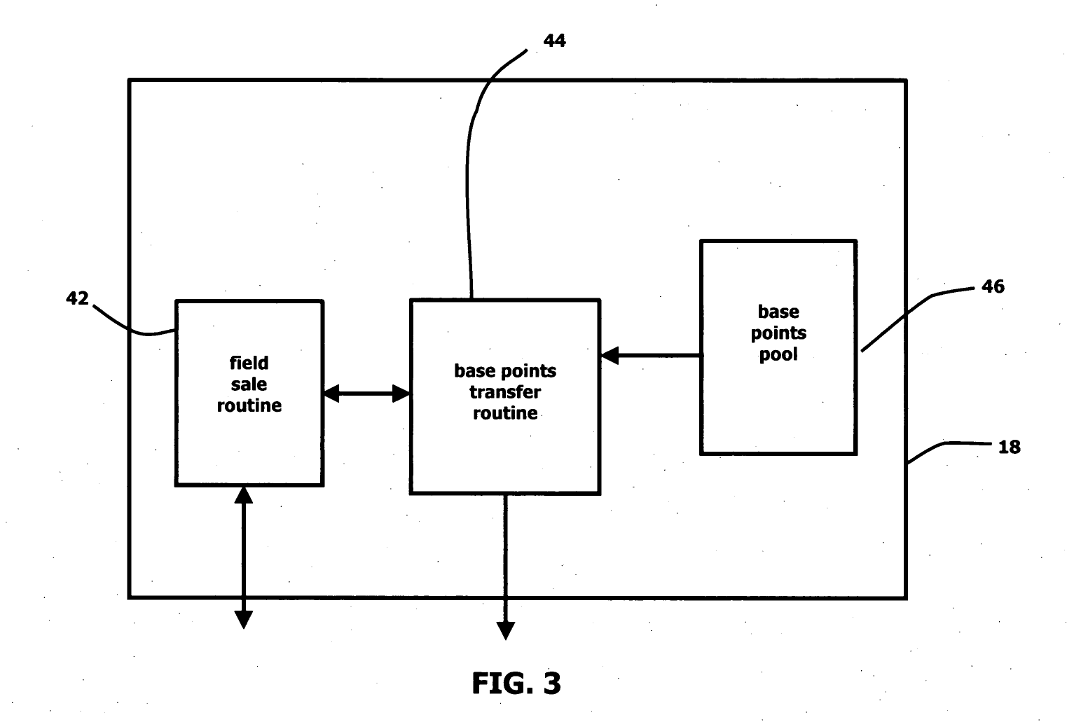

Referring now to FIG. 3, base 18 is in communication with each master control center 10, in the illustrated embodiment by means of a computer, network such as the Internet. The operator of each field uses this communications connection to purchase points from base 18 using field sale routine 42, which is in communication with field purchase routine 34 of master control center 10. Base points transfer routine 44 is operable to transfer points from base points pool 46 to points transfer routine 38 of master control center 10. Various means for making electronic purchases of this type are well known in the art. Alternatively, base 18 could create pre-loaded electromagnetically readable cards that are physically distributed to field operators, and may be read by master control center 10 in order to increase the number of points available to players in a game controlled by master control center 10. In each embodiment, it will be seen that base 18 acts as a means of tracking the purchases of points made by each field operator through the system, and thus allocates those points that the field operator has available to allocate to individual game players.

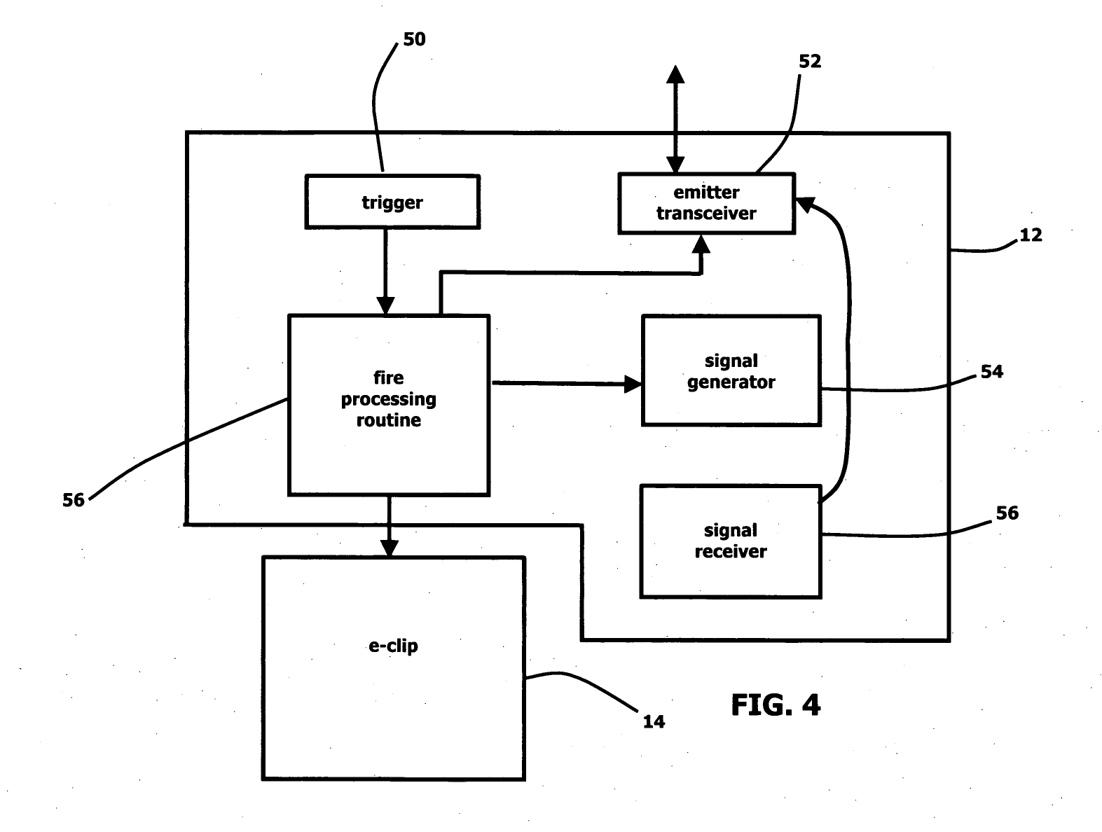

Referring now to FIG. 4, emitter 12 in the illustrated embodiment is a device capable of communicating with master control center 10 and an associated e-clip 14, and of emitting a signal from signal generator 54 that is used during game play. The signal may be an infrared beam, a laser beam, or any other type of electromagnetic signal. In the illustrated embodiment, each emitter 12 is also capable of receiving a signal sent by another emitter 12 at signal receiver 56, although in alternative embodiments the capability of transmitting a signal and receiving a signal may be split into two physically separate pieces of equipment. For example, the signal receiver part of the equipment may be worn on the player's head, chest, or other body area. Multiple signal receivers 56 may be employed as well in alternative embodiments. Emitter 12 in the illustrated embodiment is capable of receiving configuration information relative to game play at emitter transceiver 52, such as, for example, the role a particular player using that emitter 12 has been assigned during game play, and the “rate of fire” allowed to that player, that is, the rate at which the emitter will emit an infrared or other signal that may “hit” another player, that is, be detected by the other player's emitter 12. Other data as already described above with respect to master control center 10 may also be transferred to and from each emitter 12 in various embodiments. Activation of signal generator 54 is provided by trigger 50, which may include any type of switch or other activation means operable by a player to whom a particular emitter 12 is assigned. Fire processing routine 56 receives the trigger 50 input and activates signal generator 54, as well as sending a signal in the illustrated embodiment that the signal generator 54 has been activated to master control center 10 by means of emitter transceiver 52. In addition, fire processing routine 56 communicates with e-clip 14 as explained below.

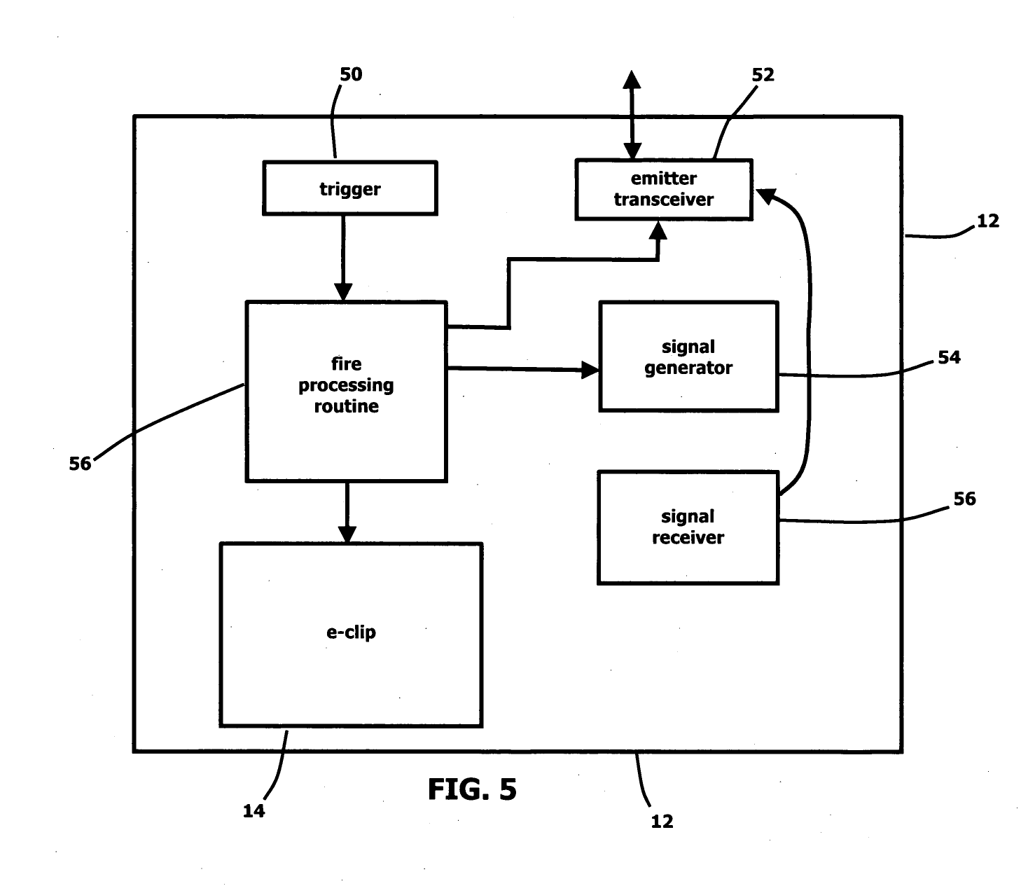

Still referring now to FIG. 4, an e-clip 14 is associated with each emitter 12. In FIG. 4, e-clip 14 is a physically separate device from emitter 12, although in alternative embodiments e-clip 14 may be physically integrated with the associated emitter 12 as shown in FIG. 5. The function of e-clip 14 is to store information relevant to the number of points available to a player during game play, and/or optionally other game-specific data. In the illustrated embodiment, e-clip 14 is implemented as a “smart” card that stores digital information through electronic or magnetic means, although in alternative embodiments any other type of information storage device may be used. Information is transferred to e-clip 14 (such as, for example, an increase in the number of rounds of ammunition associated with an e-clip 14) by charger 16, as shown in FIG. 2, which may be implemented in the illustrated embodiment by any of the various technologies as are known in the art as capable of transferring information to a smart card. Charger 16 is capable of communicating with master control center 10 in various embodiments, although this is not required in all embodiments in the case where base 18 may directly transfer points for allocation from a points pool to charger 16. In the illustrated embodiment, however, charger 16 is implemented as a peripheral device in communication with the computer that serves as master control center 10. E-clip 14 communicates with charger 16 in the illustrated embodiment by placing e-clip 14 into a slot or other receiving area of charger 16, such that a direct electrical connection is made for information transfer. In alternative embodiments, e-clip 14 could communicate with charger 16 by wireless communications. In other alternative embodiments, charger 16 could be removed from the system and each e-clip 14 could be a disposable card that is pre-configured with a certain number of points. Once those points are expended, the player simply purchases another e-clip 14 to continue game play. In alternative embodiments where e-clip 14 is integrated with emitter 12, as shown in FIG. 5, charger 16 would directly interface with emitter 12 for purposes of transferring information to e-clip 14.

The information on each e-clip 14 is preferably although not necessarily encoded, such that points may only be downloaded through a master control center 10 associated with base 18. Various means of encoding digital information are known in the art. It will be seen that by encoding the points information stored at each e-clip 14, the provider responsible for maintaining base 18 can control the purchase of all points downloaded to all e-clips 14 associated with the system. Individual players will not be able to surreptitiously add points to their e-clips 14 because they will not have access to the key or other decoding mechanism necessary in order to do so. Likewise, the field operator who controls a particular master control center 10 will also be unable to produce “counterfeit” points for sale to its players because it also will not have access to the key or other decoding mechanism necessary to create points. By controlling the allocation of points through a purchase system in this manner, it will be seen that the system monetizes game play just as the purchase of paintballs at FPO fields monetizes paint ball game play, but also offers the expanded game play options and opportunities only available with a system based on electromagnetic emitters. In fact, the system of this particular embodiment of the invention is superior to the FPO policy of paintball fields, since it controls the sale of points not only to players but also to field operators, who in the paintball business model would be free to purchase paintballs from any desired provider.

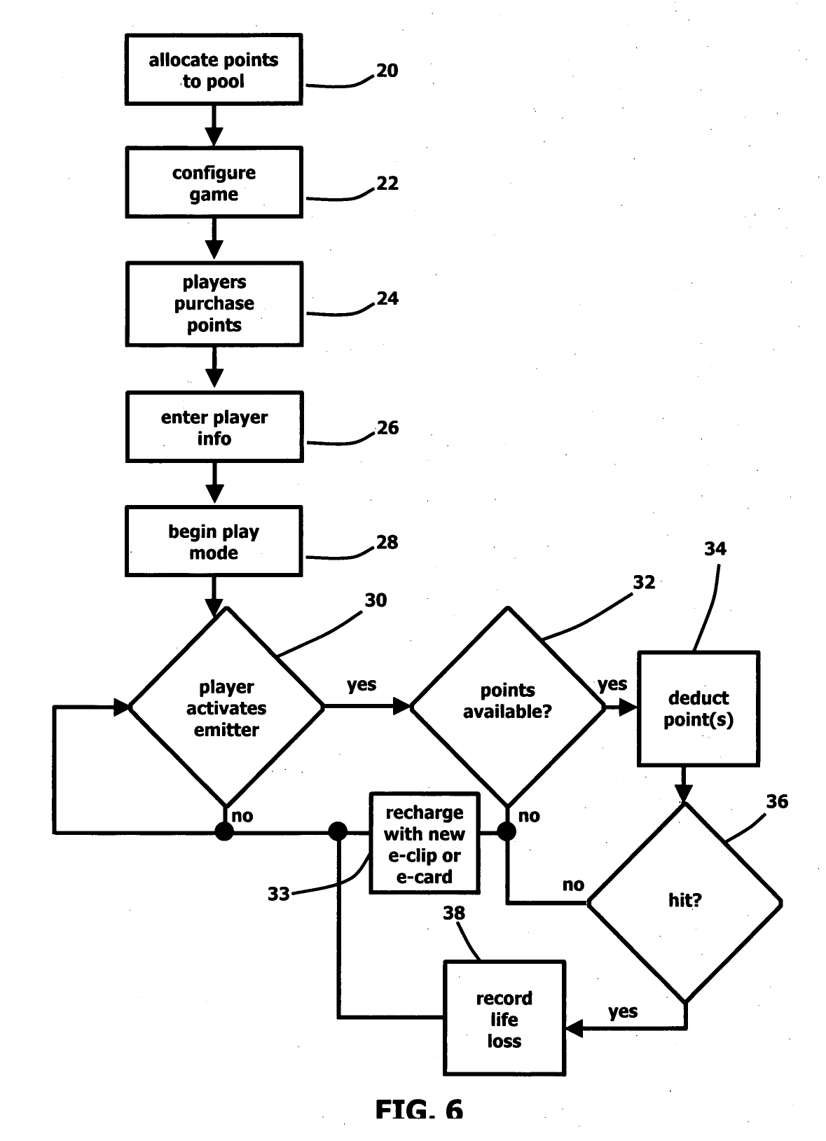

Referring now to FIG. 6, the steps in setting up the system for game play according to a particular embodiment of the present invention may be described. The field operator begins by communicating with base 18 by means of master control center 10 in order to purchase points at step 20. These points will be held in an available pool so that the field operator will have sufficient points to allocate to players during game play. As the supply of points in the pool begins to drop, the field operator may periodically purchase additional points. Alternatively, master control center 10 may be programmed to automatically purchase additional points upon certain conditions, such as the pool at master control center 10 dropping below a certain threshold. In another alternative, since in the illustrated embodiment the transaction is a simple electronic transfer, master control center 10 could act as a mere pass-through, such that points ordered through master control center 10 by players are ordered on a real-time basis from base 18 and passed to players immediately upon receipt.

Next, master control center 10 must be configured for the type of game chosen by the players or field operator, and any variables associated with that game must be set, at step 22. For example, it may be necessary to identify at master control center 10 which emitters 12 from a possible pool of available emitters will be used during a particular game. In addition, it must be determined what configuration should be used for each emitter 12 to be employed, corresponding with the various roles that may be assigned to individual players. For example, different players may have different rates of fire, and some players may have special abilities (such as “healing” other players), while other players lack such special ability.

In addition, each player must purchase sufficient points as desired for game play, which are downloaded from master control center 10 to an e-clip 14, at step 24. The download may occur directly between charger 16 and an e-clip 14 as in the illustrated embodiment of FIG. 1, or alternatively may be performed by a connection between charger 16 and the emitter 12 to which an e-clip 14 is attached. Although emitters 12 may be issued to players arriving at a field for play, it may be seen that the system in the illustrated embodiment would also allow a player to purchase and keep his or her own emitter 12 if desired. This may be advantageous for certain players who wish to purchase customized or top-of-the-line equipment in order to enhance their game play experience. The use of an e-clip 14 that is physically separate from emitter 12, as in the illustrated embodiment, allows players to have the option of changing emitters 12 if desired for different game scenarios. The use of a separate e-clip 14 also allows a player to retain the e-clip 14 after game play and use the stored points at the same field or other associated fields in the future. The use of e-cards 17 as described above also allows for this flexibility of play. The player may also carry multiple e-clips 14 during game play, or multiple e-cards 17, such that if one e-clip 14 is drained of points then the player can quickly remove that e-clip 14 and replace it with another e-clip 14 in order to continue playing, or reload the e-clip with pre-purchased points such as by an e-card 17, at step 33 as described below.

Before beginning actual game play, each player may, in the illustrated embodiment, be entered into the game software maintained at master control center 10, as shown at step 26. Players may keep a profile that includes such information as an identification string for that player (such as a nickname) and the experience level or rank of the player. The experience level or rank may be merely offered as a reward or incentive, such as where reaching a particular rank entitles the player to discounts or free goods or services, or it may be relevant to game play, such as allowing the player to use a wider variety of configurations of emitter 12 or take on other roles. Information may be entered manually, or may be associated with a computer-readable identification card issued to players. New players may simply receive a beginning or default value for experience level or rank. Once all parameters for the game are set, the players are briefed on their missions and the various rules and safety precautions before being escorted to the field to begin play. In a timed game, a signal may be sent to master control center 10 once a referee determines that play officially begins, and master control center 10 begins monitoring progress of the game at step 28.

Once play is underway, master control center 10 monitors activity at step 30 to determine if any player has activated his or her emitter 12. If a player does attempt to active his or her emitter 12, then the system (either through master control center 10 or at that player's emitter 12 in various embodiments) will check that points are available at e-clip 14, this process being performed at step 32. If so, then the appropriate number of points will be deducted from the total stored on e-clip 14 at step 34. In one embodiment, emitter 12 will include a mechanism to warn the player that he or she is low on points or that all points have been expended, such as by the lighting of an LED indicator lamp or audible warning. Emitter 12 will also keep track of when the player is “hit” by another player's emitter 12 at step 36, and that information may be transmitted to master control center 10 at step 38. In a game configuration where a player is given a number of “lives,” then a hit may be used to deduct from the number of lives maintained by the player. A visual and/or audio indicator may also be activated on emitter 12 when the player is “killed” or all lives are expended. If it is determined that no points are available at step 32, then at step 33 the player may recharge by the insertion of another e-clip or the use of an e-card, depending upon the particular embodiment of the invention employed.

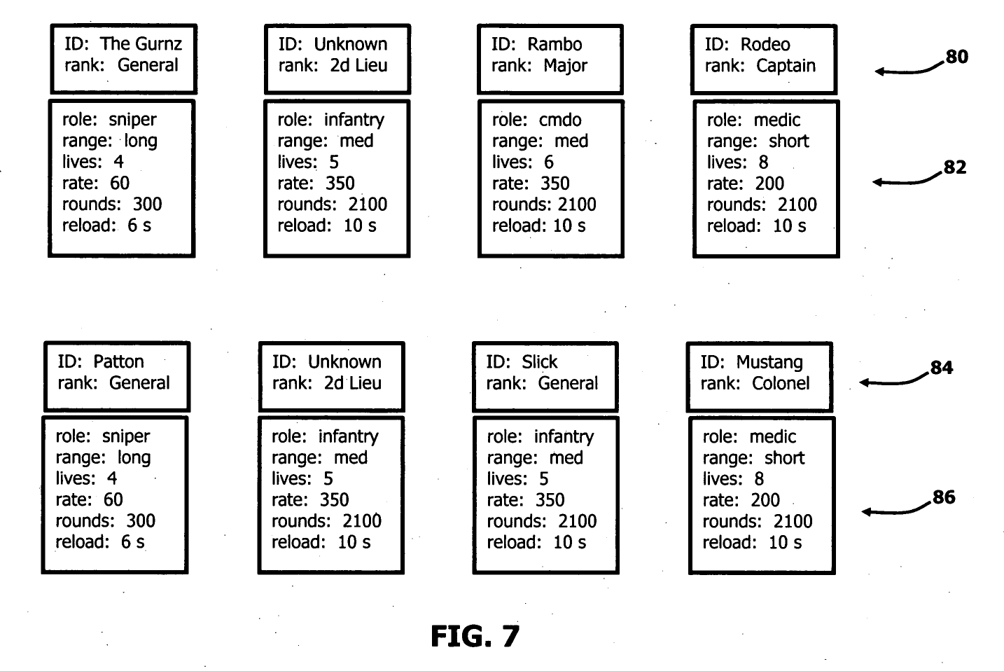

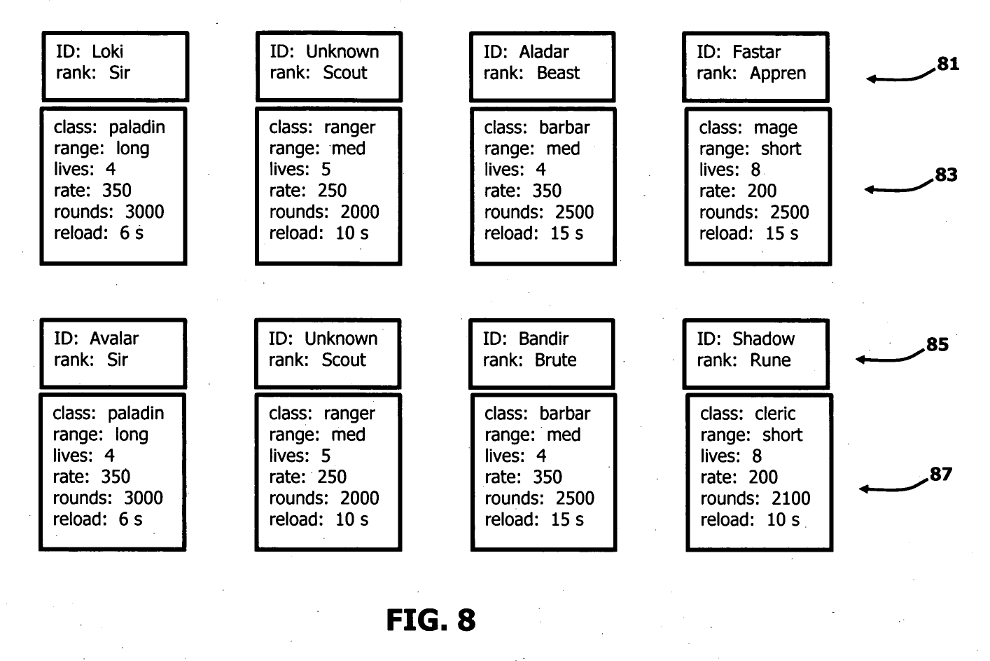

A particular embodiment of the present invention and its set-up having been described above, some examples-of game play using the embodiment will now be provided with reference to FIGS. 7 and 8. It should be understood that these are examples only, and that neither the invention nor the illustrated embodiment are limited to these particular examples of game configuration. In a first example of FIG. 7, a game is played using a military scenario configuration. The players in this game will simulate soldiers fighting on a battlefield. Each player 80 on team #1 and player 84 on team #2 have associated with them a player configuration 82 or 86, respectively, which consists of a role; a range; a number of lives; a rate of fire; a number of rounds per clip; and a reload phase. Each player also has a set number of rounds of ammunition that is equivalent to the number of points purchased by that player through master control center 10 and stored at this player's e-clip 14. In this example the e-clip 14 is a physical device, such as a removable smart card, and thus each player may carry multiple e-clips 14, so the number of points is associated with each e-clip 14 carried by the player.

As may be seen, the role played by each player in the scenario of FIG. 7 impacts other parameters of game play. The sniper player, for example, has an emitter 12 that is configured to score a hit even at long range, while the infantry role means that the player's emitter 12 will be configured for medium range operation, and the medic role means that the player's emitter 12 will be configured only to score a hit when fired at short ranges. Likewise, the rate of fire assigned to the emitter 12 of the player given the sniper role is relatively slow, while that of the player given the infantry role is much faster. The number of lives assigned to a player based on his or her role may be used to balance the advantages and disadvantages of various roles; for example, while the medic role means that the player will be less effective at eliminating other players, the player is given more lives and thus may find the role desirable for that reason.

The rank and/or level of a player may affect game play in a number of ways. In a preferred embodiment, a player gains rank or levels by participating in previous games. In particular, in the preferred embodiment the player may accumulate experience points for performing game actions, such as scoring a “kill” against an opposing player. A set amount of experience points gained will allow the player to reach the next rank or level. An increase in rank or level may give the player various advantages during game play in various embodiments of the invention; for example, the player may be given a greater range, greater rate of fire, faster reload time, or additional abilities. A high-ranking medic, for example, may be able to heal more players. In this way, players are encouraged to play more often and to hone their skills in order to move up in rank and level, and thereby gain relevant in-game abilities that will increase their enjoyment of the game.

The medic in the scenario of FIG. 7 has a special ability that allows the player fulfilling that role to transfer lives to a teammate, thus preventing that teammate from being eliminated from play when that player's life total would otherwise be reduced to zero. This ability uses points stored in the medic player's e-clip 14, although the number of points necessary in order to effect the “healing” function may be set as a game parameter in the illustrated embodiment.

In the scenario illustrated in FIG. 8, a fantasy-themed game is being played. Each player represents a sorcerer or other fantasy-theme figure, chosen from a number of available classes, who is armed with an emitter 12 that serves as, for example, a sorcerer's wand, a cleric's staff, or a barbarian's club. The abilities of this wand, staff, club, or other simulated weapon or item are activated by the expenditure of points stored at each player's e-clip 14. The specific parameters associated with each emitter 12 during game play vary as the class to which the player is assigned. As in the case of the scenario of FIG. 7, each player 81 or 85 is associated with various parameters 83 and 87, respectively, for this reason. In this case, for example, the player occupying the cleric class takes on a role similar to that of the medic in the military scenario of FIG. 7.

The present invention has been described with reference to certain preferred and alternative embodiments that are intended to be exemplary only and not limiting to the full scope of the present invention as set forth in the appended claims.

What is claimed is:

1. An elimination game system utilizing transferable game points, comprising:
(a) a plurality of emitters;
(b) a plurality of e-clips, each of said e-clips in communication with one of said emitters and comprising a point storage medium;
(c) a master control center in communication with each of said plurality of emitters, said master control center comprising:
(i) a points pool storage medium;
(ii) a transfer routine operable to transfer points to and from said points pool storage medium; and
(iii) a points purchase routine; and
(d) a base in communication with said master control center, said base comprising a points sale routine.

2. The system of claim 1, wherein said emitters comprise a signal generator.

3. The system of claim 2, wherein said signal generator is an electromagnetic signal generator.

4. The system of claim 3, wherein said electromagnetic signal generator is an infrared signal generator.

5. The system of claim 2, wherein said emitter further comprises:
(a) a trigger; and
(b) a fire processing routine in communication with said trigger, said signal generator, and said e-clip point storage medium.

6. The system of claim 1, wherein said master control center further comprises a game configuration routine.

7. The system of claim 6, further comprising a charger in communication with said game configuration routine and said points transfer routine.

8. The system of claim 7, further comprising at least one e-card connectable to each of said plurality of e-clips.

9. The system of claim 7, wherein said charger comprises an emitter connector.

10. The system of claim 9, wherein each of said plurality of emitters comprises a charger connector.

11. A method for utilizing transferable points in an elimination game, comprising the steps of:
(a) transferring a block of points from a base to a master control center;
(b) choosing a game type from a plurality of game type profiles at the master control center;
(c) assigning an emitter to each of a plurality of players;
(d) for each of the plurality of players, assigning a subset of said block of points to such player and storing each of the subsets of the block of points on an e-clip associated with such player; and
(e) in response to the activation of an emitter by one of the plurality of players, determining if a predetermined number of points are available at the subset of said block of points purchased for such player and stored at the e-clip associated with such player, and if so deducting the predetermined number of points from such subset of the block of points and activating a signal from the emitter assigned to such player.

12. The method of claim 11, wherein said assigning a subset of said block of points to such player and storing each of the subsets of the block of points on an e-clip associated with such player step comprises the step of connecting the e-clip associated with such player to a charger in communication with the master control center.

13. The method of claim 12, wherein at least one of the players is associated with more than one e-clip.

14. The method of claim 11, wherein said assigning a subset of said block of points to such player and storing each of the subsets of the block of points on an e-clip associated with such player step comprises the step of connecting the emitter associated with such player to a charger in communication with the master control center.

15. The method of claim 11, further comprising the step of registering a hit for one of the players.

16. The method of claim 15, further comprising the step of, if a hit is registered, reducing a total number of lives associated with the player for whom a hit was registered.

17. The method of claim 16, further comprising the step of assigning a role to each of the players.

18. The method of claim 15, wherein at least one of the players is assigned a healing role, and in response to a hit registered against a player by the player assigned a healing role increasing a total number of lives associated with the player for whom a hit was registered.

19. The method of claim 17, wherein said step of assigning a role to each of the players comprises the steps of assigning at least one of a rate of fire and a range to each of the players.

20. The method of claim 19, wherein said step of assigning a role to each of the players comprises the step of assigning a rounds per clip total and reload phase time to each of the players.
